(19) United States
(12) Patent Application Publication
(10) Pub. No.: US 2018/0131397 A1
(43) Pub. Date: May 10, 2018

(54) ADAPTIVE ANALOG INTERFERENCE CANCELLING SYSTEM AND METHOD FOR RF RECEIVERS

(71) Applicant: QUALCOMM Incorporated, San Diego, CA (US)

(72) Inventors: Mohammad Emadi, San Jose, CA (US); Mazhareddin Taghivand, Campbell, CA (US); Alireza Khalili, Sunnyvale, CA (US)

(21) Appl. No.: 15/343,791

(22) Filed: Nov. 4, 2016

(51) Int. Cl. H04B 1/10; H04L 27/14

(52) U.S. Cl. CPC H04B 1/1081; H04B 1/1036; H04L 27/14

(57) ABSTRACT

A method of and system for processing a received signal is disclosed. The method includes generating a corrected radio frequency (RF) signal based on an RF feedback signal and an incoming RF signal, the incoming RF signal includes a wanted signal and an interfering signal. The method also includes down-converting the corrected RF signal to a corrected in-phase baseband signal and a corrected quadrature-phase baseband signal; extracting, based on a baseband signal of an aggressor signal, an in-phase baseband signal of the interfering signal from the corrected in-phase baseband signal; extracting, based on the baseband signal of the aggressor, a quadrature-phase baseband signal of the interfering signal from the corrected quadrature-phase baseband signal; up-converting the extracted interfering signals to produce the RF feedback signal; and generating a second corrected RF signal based on the second RF feedback signal and the incoming RF signal.

### BACKGROUND

Aspects of the present disclosure relate generally to wireless communications, and more particularly, to a radio frequency (RF) receiver capable of canceling RF interference.

Radio-frequency interference occurs when a signal emitted by one device gets unintentionally received by another. The interference can desensitize an RF receiver or cause other non-linear effects, such as second-order and third-order product intermodulation that can degrade the overall system performance. However, as chip designers try to meet the industry demand of designing single-chip solutions that support RF bands for many technologies, the on-chip coupling of these frequency bands becomes an increasingly complicated issue for designers to address. For example, in frequency division duplexing systems (FDD), such as CDMA or LTE-FDD, the transmit (uplink) and receive (downlink) traffic are each carried by different, but paired radio channels. As the receiver receives its wanted signal, the transmitter transmits its relatively larger signal on a contiguous frequency band that may eventually couple or leak back into the receiver. Since the duplex spacing in FDD is minimal, the coupling transmit signal will appear at the receiver as in-band interference. Coexistence systems, such as Wi-Fi and LTE/LTE-U, also illustrate the same problem because the wanted signal at the receiver and the signals of the coexistence systems, in some cases, have over-lapping frequency bands of operation.

Conventional systems use external filters such as Surface Acoustic Wave (SAW) RF filters and Bulk Acoustic Wave (BAW) RF filters to attenuate such in-band and out-of-band interference. However, these external filters are expensive, and have insertion loss that further degrades critical receiver performance parameters, such as receiver sensitivity and receiver noise figure.

### SUMMARY

The disclosure is directed to an adaptive feedback circuit that cancels both in-band and out-of-band RF interference to improve the performance of wireless communication systems, effectively eliminating the need for external, front-end filters.

The adaptive feedback circuit described herein is unaffected by the occurrence of a residual side band signal or IQ mismatch. The interfering signal and the wanted signal may also have the same or similar frequency without affecting performance of the circuit. In some implementations, an exemplary embodiment, the adaptive feedback circuit implements a Least Means Squared (LMS) algorithm in the analog domain at baseband making it less sensitive to RF non-idealities caused by changes in temperature, voltage, and semiconductor process. To use the circuit, the source of the interference is known and its signal at baseband is accessible for frequency up-conversion back to RF. The adaptive feedback circuit may use the up-converted signal to cancel the interference from the incoming RF signal. Accordingly, the adaptive feedback circuit may significantly attenuate, if not eliminate, the interference in a wireless communication system.

One implementation disclosed herein is a method of processing a received signal. The method includes generating a corrected radio frequency signal based on an RF feedback signal and an incoming RF signal. The incoming RF signal including a wanted signal and an interfering signal. The method also includes down-converting the corrected RF signal to a corrected in-phase baseband signal and a corrected quadrature-phase baseband signal; extracting, based on a baseband signal of an aggressor, an in-phase baseband signal of the interfering signal from the corrected in-phase baseband signal; extracting, based on the baseband signal of the aggressor, a quadrature-phase baseband signal of the interfering signal from the corrected quadrature-phase baseband signal; up-converting the extracted interfering signals to produce a second RF feedback signal; and generating a second corrected RF signal based on the second RF feedback signal and the incoming RF signal. In some implementations, generating the corrected RF signal comprises subtracting the RF feedback signal from the incoming RF signal. In some implementations, generating the second corrected RF signal comprises subtracting the second RF feedback signal from the incoming RF signal. In some implementations, the extracted interfering signals are analog.

In some implementations, the interfering signal of the incoming RF signal correlates to the baseband signal of the aggressor, the baseband signal of the aggressor comprises an in-phase baseband signal and a quadrature-phase baseband signal. In some implementations, the second corrected RF signal includes the incoming RF signal having a majority of the interfering signal removed. In some implementations, an analog to digital conversion of the corrected in-phase baseband signal and the corrected quadrature-phase baseband signal is delayed until after a power of the interfering signal falls below a predetermined threshold

In some implementations, the incoming RF signal is amplified prior to generating a corrected radio frequency signal. In some implementations, the corrected radio frequency signal is amplified prior to down-converting the corrected RF signal.

In some implementations, extracting the in-phase baseband signal of the interfering signal comprises generating a first multiplier signal based on the corrected quadrature-phase baseband signal. The method also includes generating an in-phase integrated signal based on the first multiplier signal and generating the in-phase baseband signal of the interfering signal based on the in-phase integrated signal.

In some implementations, extracting the interfering signal from the corrected quadrature-phase baseband signal comprises generating a third multiplier signal based on the corrected in-phase baseband signal. The method also includes generating a quadrature-phase integrated signal based on the third multiplier signal and generating the quadrature-phase baseband signal of the interfering signal based on the quadrature-phase integrated signal.

In some implementations, the method includes generating the first multiplier signal comprises generating a fifth multiplier signal by multiplying the corrected in-phase baseband signal and the in-phase baseband signal of the aggressor.

In some implementations, the method includes generating a sixth multiplier signal by multiplying the corrected quadrature-phase baseband signal and the quadrature-phase baseband signal of the aggressor. In some implementations, the method includes generating the first multiplier signal by combining the fifth multiplier signal and the sixth multiplier signal.

In some implementations, generating the in-phase baseband signal of the interfering signal comprises generating a ninth multiplier signal by multiplying the in-phase integrated signal and the in-phase baseband signal of the aggressor. In some implementations, the method includes generating a tenth multiplier signal by multiplying the quadrature-phase integrated signal and the quadrature-phase baseband signal of the aggressor. In some implementations, generating the in-phase baseband signal of the interfering signal by combining the ninth multiplier signal and the tenth multiplier signal.

In some implementations, generating a third multiplier signal based on the corrected in-phase baseband signal comprises generating a seventh multiplier signal by multiplying the corrected quadrature-phase baseband signal and the in-phase baseband signal of the aggressor. In some implementations, the method includes generating generate an eighth multiplier signal by multiplying the corrected in-phase baseband signal and the quadrature-phase baseband signal of the aggressor and generating the third multiplier signal by combining the seventh multiplier signal and the eighth multiplier signal.

In some implementations, generating the quadrature-phase baseband signal of the interfering signal comprises generating an eleventh multiplier signal by multiplying the in-phase integrated signal and the quadrature-phase baseband signal of the aggressor and generating a twelfth multiplier signal by multiplying the quadrature-phase integrated signal and the in-phase baseband signal of the aggressor. In some implementations, generating the quadrature-phase baseband signal of the interfering signal by combining the eleventh multiplier signal and the twelfth multiplier signal.

In another aspect, the present disclosure is directed to a system comprising a subtractor adapted to generate a corrected radio frequency (RF) signal from an incoming RF signal and an RF feedback signal. The incoming RF signal including a wanted signal and an interfering signal. In some implementations, the system includes a down-converter adapted to frequency convert the corrected RF signal to a corrected in-phase baseband signal and a corrected quadrature-phase baseband signal. The system also includes a first correlator adapted to extract an in-phase baseband signal of the interfering signal from the corrected in-phase baseband signal. In some implementations, the system includes a second correlator adapted to extract a quadrature-phase signal of the interfering signal from the corrected quadrature-phase baseband signal and an up-converter adapted to frequency convert the extracted interfering signals to produce a second RF feedback signal.

In some implementations, the system includes the subtractor is further adapted to generate the corrected RF signal by subtracting the RF feedback signal from the incoming RF signal. In some implementations, the extracted interfering signals are analog. In some implementations, the interfering signal of the incoming RF signal correlates to the baseband signal of the aggressor, the baseband signal of the aggressor comprises an in-phase baseband signal and a quadrature phase baseband signal.

In some implementations, the corrected RF signal includes the incoming RF signal having a majority of the interfering signal removed. In some implementations, the system also includes a low noise amplifier (LNA), wherein the incoming RF signal is amplified by the LNA prior to receipt by the subtractor. In some implementations, the system also includes a low noise amplifier (LNA), wherein the corrected RF signal is amplified by the LNA prior to receipt by the down-converter.

In some implementations, the system includes a first low-pass filter, wherein the in-phase baseband signal of the corrected RF signal is filtered by a low-pass filter prior to receipt by the first correlator; and a second low-pass filter, wherein the quadrature-phase baseband signal of the corrected RF signal is filtered by a low-pass filter prior to receipt by the second correlator.

In some implementations, the first correlator comprises a first multiplier adapted to generate a first multiplier signal from the corrected quadrature-phase baseband signal. The system also includes an in-phase integrator adapted to generate an in-phase integrated signal based on the first multiplier signal; and a second multiplier adapted to generate the in-phase baseband signal of the interfering signal based on the in-phase integrated signal.

In some implementations, the second correlator comprises a third multiplier adapted to generate a third multiplier signal based on the corrected in-phase baseband signal. The system includes a quadrature-phase integrator adapted to generate a quadrature-phase integrated signal based on the third multiplier signal; and a fourth multiplier adapted to generate the quadrature-phase baseband signal of the interfering signal based on the quadrature-phase integrated signal.

In some implementations, the first multiplier comprises a fifth multiplier adapted to generate a fifth multiplier signal based on the corrected in-phase baseband signal and the in-phase baseband signal of the aggressor. In some implementations, the system includes a sixth multiplier adapted to generate a sixth multiplier signal based on the corrected quadrature-phase baseband signal and the quadrature-phase baseband signal of the aggressor. In some implementations, the system includes a first in-phase combiner that generates the first multiplier signal based on the fifth multiplier signal and the sixth multiplier signal.

In some implementations, the second multiplier comprises a ninth multiplier adapted to generate a ninth multiplier signal based on the in-phase integrated signal and the in-phase baseband signal of the aggressor. In some implementations, the system includes a tenth multiplier adapted to generate a tenth multiplier signal based on the quadrature-phase integrated signal and the quadrature-phase baseband signal of the aggressor; and a second in-phase combiner that generates the in-phase baseband signal of the interfering signal based on the ninth multiplier signal and the tenth multiplier signal.

In some implementations, the third multiplier comprises a seventh multiplier adapted to generate a seventh multiplier signal based on the corrected quadrature-phase baseband signal and the in-phase baseband signal of the aggressor. In some implementations, the system also includes an eighth multiplier adapted to generate an eighth multiplier signal based on the corrected in-phase baseband signal and the quadrature-phase baseband signal of the aggressor; and a first quadrature-phase combiner that generates the third multiplier signal based on the seventh multiplier signal and the eighth multiplier signal.

In some implementations, the forth multiplier comprises an eleventh multiplier adapted to generate an eleventh multiplier signal based on in-phase integrated signal and the quadrature-phase baseband signal of the aggressor. In some implementations, the system includes a twelfth multiplier adapted to generate a twelfth multiplier signal based on the quadrature-phase integrated signal and the in-phase baseband signal of the aggressor; and a second quadrature-phase combiner that generates the quadrature-phase baseband signal of the interfering signal based on the eleventh multiplier signal and the twelfth multiplier signal.

In another aspect, the present disclosure is directed to a non-transitory computer readable storage medium to store a computer program to execute method for processing a received signal. The method comprises generating a corrected radio frequency (RF) signal based on an RF feedback signal and an incoming RF signal. The incoming RF signal including a wanted signal and an interfering signal. In some implementations, the non-transitory computer readable storage medium includes down-converting the corrected RF signal to a corrected in-phase baseband signal and a corrected quadrature-phase baseband signal; and extracting, based on a baseband signal of an aggressor, an in-phase baseband signal of the interfering signal from the corrected in-phase baseband signal;

In some implementations, the non-transitory computer readable storage medium includes extracting, based on the baseband signal of the aggressor, a quadrature-phase baseband signal of the interfering signal from the corrected quadrature-phase baseband signal; and up-converting the extracted interfering signals to produce the RF feedback signal.

In another aspect, the present disclosure is directed to a method of processing a received signal, the method comprising generating a corrected radio frequency (RF) signal based on an RF feedback signal and a an incoming RF signal, wherein the incoming RF signal includes a wanted signal and an interfering signal. In some implementations, the method includes down-converting the corrected RF signal to a corrected baseband signal, the interfering signal having a first magnitude and a first phase angle. In some implementations, the method includes comparing the corrected RF signal to a baseband signal of an aggressor having a second magnitude and a second phase angle and determining a first association between the first magnitude and the second magnitude.

In some implementations, the method includes determining a second association between the first phase angle and the second phase angle. The method includes, in response to determining a first and second association, generating a signal having a third magnitude and a third phase angle; wherein the third magnitude is relative to the first magnitude in response to determining the first association and the second association; and up-converting the signal to produce the RF feedback signal.

In another aspect, the present disclosure is directed to a communication circuit for processing a received signal, the communication circuit comprising means for generating a corrected radio frequency (RF) signal based on an RF feedback signal and an incoming RF signal. The incoming RF signal including a wanted signal and an interfering signal. In some implementations, the method includes means for down-converting the corrected RF signal to a corrected baseband signal, the interfering signal having a first magnitude and a first phase angle. In some implementations, the method includes means for comparing the corrected RF signal to a baseband signal of an aggressor having a second magnitude and a second phase angle and means for determining a first association between the first magnitude and the second magnitude.

In some implementations, the method includes means for determining a second association between the first phase angle and the second phase angle. The method includes, in response to determining a first and second association, means for generating a signal having a third magnitude and a third phase angle. The third magnitude is relative to the first magnitude in response to determining the first association and the second association. The method includes means for up-converting the signal to produce the RF feedback signal.

### BRIEF DESCRIPTION OF THE DRAWINGS

The accompanying drawings, which are incorporated herein and constitute part of this specification, illustrate examples described in the disclosure, and together with the general description given above and the detailed description given below, serve to explain the features of the various implementations.

FIG. 1 is a circuit diagram depicting an adaptive feedback receiver for canceling RF interference, in accordance with an illustrative implementation.

FIG. 2A is a block diagram depicting an in-phase correlator capable of extracting an in-phase baseband signal correlated to an in-phase aggressor signal, in accordance with an illustrative implementation.

FIG. 2B is a block diagram depicting a quadrature-phase correlator capable of extracting a quadrature-phase baseband signal correlated to a quadrature-phase aggressor signal, in accordance with an illustrative implementation.

FIG. 3 is a flow diagram depicting a process for canceling interference from a received RF signal, in accordance with an illustrative implementation.

FIG. 4 is a flow diagram depicting a process for canceling interference from a received RF signal, in accordance with an illustrative implementation.

FIG. 5 is a flow diagram depicting a process for canceling interference from a received RF signal, in accordance with an illustrative implementation.

Like reference numbers and designations in the various drawings indicate like elements.

### DETAILED DESCRIPTION

Various implementations will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the disclosure or the claims.

It should be understood that implementations of the present disclosure may be used in a variety of applications. Although the present disclosure is not limited in this respect, the circuits disclosed herein may be used in many apparatuses such as in the transmitters and receivers of a radio system. Radio systems intended to be included within the scope of the present disclosure include, by way of example only, cellular radiotelephone communication systems, satellite communication systems, two-way radio communication systems, one-way pagers, two-way pagers, personal communication systems (PCS), personal digital assistants (PDA's) and the like.

Types of cellular radiotelephone communication systems intended to be within the scope of the present disclosure include, but are not limited to, Frequency Division Multiple Access (FDMA) systems, Time Division Multiple Access (TDMA) systems, Extended-TDMA (E-TDMA) cellular radiotelephone systems, Global System for Mobile Communications (GSM) systems, Code Division Multiple Access (CDMA) systems (particularly, Evolution-Data Optimized (EVDO) systems), CDMA-2000 systems, Universal Mobile Telecommunications Systems (UMTS) (particularly, Wideband Code Division Multiple Access (WCDMA), Long Term Evolution (LTE) systems, Single Radio LTE (SRLTE) systems, Simultaneous GSM and LTE (SGLTE) systems, High-Speed Downlink Packet Access (HSDPA) systems, and the like), Code Division Multiple Access 1x Radio Transmission Technology (1x) systems, General Packet Radio Service (GPRS) systems, Wi-Fi systems, Bluetooth systems, Near-Field Communication systems, Personal Communications Service (PCS) systems, and other protocols that may be used in a wireless communications network or a data communications network

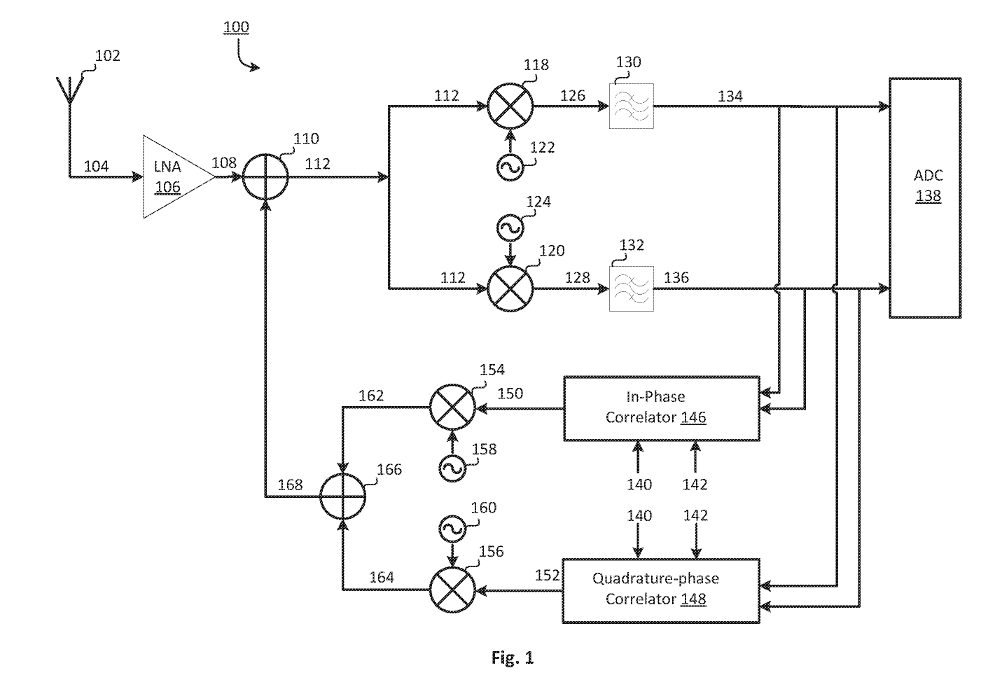

FIG. 1 is a circuit diagram depicting an adaptive feedback receiver for canceling RF interference, in accordance with an illustrative implementation. In general, the adaptive feedback receiver selectively receives and amplifies an incoming RF signal from an operating frequency band having a plurality of wanted RF signals and interfering RF signals. A subtractor generates a corrected RF signal, consisting of a wanted RF signal and one or more interfering RF signals, by subtracting an RF feedback signal from the amplified signal. A pair of RF mixers down-convert the corrected RF signal to in-phase and quadrature-phase (I/Q) baseband signals, or in some implementations, to low or moderate intermediate frequency (low-IF) signals. Low-band filters may filter the down-converted signals to improve the receiver's ability to select the wanted frequency from the incoming RF signal. Prior to the analog-to-digital conversion stage, a feedback path routes the filtered signals to one or more correlators adapted to compare the filtered signals to an aggressor baseband signal. Each correlator generates I/Q signals by extracting components from the filtered signal that correlate, in both magnitude and phase, to the aggressor baseband signal. A combiner generates a composite baseband signal from the extracted I/Q signals and a pair of mixers up-convert the composite signal to produce the RF feedback signal. For each successive cycle of the incoming RF signal, the adaptive feedback receiver generates an updated RF feedback signal that further attenuates the interfering RF signal component of the corrected RF signal. Accordingly, the adaptive feedback receiver may sufficiently cancel the interference from the incoming RF signal.

In greater detail, receiver 100 includes an antenna 102, a low-noise amplifier (LNA) 106, a subtractor 110, four mixers 118, 120, 154, 156, four local oscillators (LO) 122, 124, 158, 160, two filters 130, 132, one analog-to-digital converter (ADC) 138, one in-phase correlator 146, one quadrature-phase correlator 148, and one combiner 166. In some implementations, receiver 100 may omit antenna 102, LNA 106, mixers 118, 120, local oscillators 122, 124, and filters 130,132. That is, receiver 100 may be a feedback path comprising correlators 146, 148, mixers 154, 156, local oscillators 158, 160, combiner 166, and subtractor 110. In this configuration, the feedback path of receiver 100 may be coupled to one or more receivers to cancel both in-band and out-of-band RF interference. Receiver 100 may be implemented as a radio frequency integrated circuit (RFIC), implemented using only discrete components, or implemented using any combination thereof. As will be discussed below, in another implementation, receiver 100 can include fewer, additional, and/or different components.

While FIG. 1 illustrates receiver 100 as a homodyne or direct-conversion receiver capable of down-converting or mixing an RF signal to a baseband frequency, the adaptive feedback receiver may be any type of radio receiver architecture. For example, receiver 100 may be a super heterodyne receiver capable of converting an RF signal down to an intermediate frequency (IF) before converting to a baseband frequency. In another implementation, receiver 100 may be a homodyne receiver that does not require any down-converting mixers at the RF stage. For example, receiver 100 may extract baseband signals at zero IF by applying the RF signal directly to an I/Q demodulator. Other receiver architecture types may include a regenerative receiver, a superregenerative receiver, a tuned radio frequency (TRF) receiver, a neutrodyne receiver, a reflex receiver, a low-IF receiver, a band-pass sampling receiver, a Hartley receiver, and a Weaver receiver.

Receiver 100 may represent any type of circuit that provides RF receive capabilities. For example, receiver 100 may be a single-IC (stand-alone) receiver or a transceiver that supports both receive and transmit functionality. In some implementations, receiver 100 may work in conjunction with another stand-alone transmitter. To support interoperability, the transmitter may share its baseband signals and/or intermediate frequency signals with any component of receiver 100. In some implementations, a baseband processor used to process the baseband signals generated by a receiver or a transceiver may combine its functionality receiver 100.

Antenna 102 connects to the input of LNA 106, which has an output connected to the first input of subtractor 110. The output of subtractor 110 connects to the first inputs of mixers 118, 120. The output of mixer 118 connects to the input of filter 130, which has an output connected to ADC 138, the first input of in-phase correlator 146, and the first input of quadrature-phase correlator 148. The output of mixer 120 connects to the input of filter 132, which has an output that connects to ADC 138, the second input of in-phase correlator 146, and the second input of quadrature-phase correlator 148. The outputs of mixers 154, 160 connect to the inputs of combiner 166, which has an output that connects to the second input of subtractor 110. The second input of each mixer connects to a dedicated LO, for example, mixer 118 pairs with LO 122, mixer 120 pairs with LO 124, mixer 154 pairs with LO 158, and mixer 156 pairs with LO 160.

The second and third inputs of both in-phase correlator 146 and quadrature-phase correlator 148 connect to an in-phase aggressor baseband signal 140 and quadrature-phase aggressor baseband signal 142. As discussed herein, the aggressor signal may comprise an in-phase aggressor baseband signal and a quadrature-phase baseband aggressor signal. The aggressor signal may be a transmit signal produced by a separate or on-chip (i.e., located on the same semiconductor device) transmitter working in conjunction with receiver 100 while each paired device operates in full duplex mode (e.g., an FDD system). For example, a transceiver operating at the 850 MHz cellular band transmits signals from 824 MHz to 859 MHz, while simultaneously receiving signals between 869 MHz and 894 MHz. Despite a fixed duplex spacing of 45 MHz, the transmit signals fall in-band to the receiver because the single shared antenna tunes to the entire cellular band of 824 MHz to 894 MHz. Accordingly, the down-converted baseband signals of the transmitter act as aggressor signals that interfere with the receiver's capability to process the wanted baseband signals.

In some implementations, the aggressor signal arises from a coexistence system that transmits on the same or adjacent frequency band as receiver 100. For example, frequency band 41 (B41) commonly used by an LTE system receives signals ranging in frequency from 2496 MHz to 2690 MHz, while a Wi-Fi system may transmit an overlapping signal up to 2500 MHz. Thus, the aggressor signal of the Wi-Fi system may fall in-band to receiver 100, effectively degrading system performance. In some implementations, the aggressor signal is a separate coexistence system.

In some implementations, the aggressor signal may include an intermediate frequency (IF) or low-IF, instead of a baseband signal. For example, a super heterodyne receiver down-converts the RF signal to an intermediate frequency and then to a baseband frequency. Accordingly, the second and third inputs of both in-phase correlator 146 and quadrature-phase correlator 148 may each receive aggressor signals at an intermediate frequency instead of a baseband frequency. In some implementations, each correlator receives an aggressor signal at a baseband frequency and an aggressor signal at an intermediate frequency.

Antenna 102 may be a multi-band antenna adapted to receive an incoming RF signal 104 having a plurality of wanted RF channels and interfering RF channels. Receiver 100 may use antenna 102 exclusively or share antenna 102 with a paired transmitter. For example, receiver 100 may operate in a frequency division duplexing (FDD) system where receiver 100 receives RF signals from antenna 102, while a transmitter simultaneously broadcasts its RF signals from the same antenna 102. By way of a non-limiting example, antenna 102 may be implemented as a planar inverted F (PIFA) antenna, a planar meander line antenna, a Marconi antenna, a helical antenna, a Hertzian antenna, a dipole antenna, a half-wave dipole antenna, a folded dipole antenna, a loop antenna, a folded loop antenna, modified dipole antenna, a triangular or bowtie dipole antenna, a log periodic dipole array (LPDA) antenna, a Yagi Uda antenna, or a parabolic reflector antenna.

In some implementations, receiver 100 may include a duplexer (not shown) between antenna 102 and LNA 106. The duplexer may allow receiver 100 and a transmitter (not shown), each operating on different frequencies, to share antenna 102 while simultaneously receiving and transmitting signals. The internal filters of the duplexer may fully isolate the receiver from noise generated from the transmitter. In some implementations, the duplexer may allow some or all transmitter noise to couple or “leak” into the input of the receiver, which may contribute to the interfering signal component of incoming RF signal 104. In some implementations, receiver 100 may use a MEMS switch instead of a duplexer. In some implementations, receiver 100 may use a diplexer instead of a duplexer.

LNA 106 produces amplified signal 108 by amplifying incoming RF signal 104 to a level sufficient for further processing, such as down-converting, demodulating, and decoding. In some implementations, LNA 106 may use a programmable signal gain to improve the sensitivity of receiver 102. For example, the signal strength of incoming RF signal 104 may vary as the distance between receiver 100 and a transmitter changes or as RF effects (e.g., multipath fading and shielding) become prevalent. An LNA using a programmable gain, however, may increase or decrease the gain setting according the variations in incoming RF signal strength. In other implementations, LNA 106 may use a fixed signal gain.

The gain of LNA 106 advantageously helps suppress the noise floor introduced by the tap of incoming RF signal 104 by subtractor 110, as will be appreciated by those skilled in the art. That is, tapping the signal energy of the incoming RF signal after LNA 106 helps to minimize the impact of signal loss on the downstream components (e.g., mixers 118, 120), and potentially improves the receiver sensitivity by an appreciable amount. To this end, some implementations may include an additional LNA(s), allowing for the use of less costly components in the downstream path of receiver 100.

Subtractor 110 has two-inputs and one-output adapted to subtract the signal sensed on its first input from the signal sensed on its second input to produce a corrected signal on its output. As shown in FIG. 1, subtractor 110 subtracts RF feedback signal 168 from amplified signal 108, to produce corrected RF signal 112. In some implementations, the signal characteristics (e.g., magnitude, phase angle) of RF feedback signal 168 update from cycle to cycle of incoming RF signal 104. Accordingly, for each cycle of amplified RF signal 108, subtractor 110 further attenuates the interfering signal component of amplified RF signal 108 relative to the wanted signal component. For example, amplified RF signal 108 may comprise an 894 MHz wanted signal and an 892 MHz interfering signal. If the frequency of RF feedback signal 168 centers at 892 MHz, then the subtraction of RF feedback signal 168 from amplified RF signal 108 results in corrected signal 112 consisting of a wanted signal and an interfering signal. However, the subtraction attenuates the interfering signal by an amount equal to RF feedback signal 168. In some implementations, subtractor 110 will essentially eliminate the interfering signal from amplified RF signal 108, such that a majority of RF amplified signal 108 includes the wanted signal. In another implementation, subtractor 110 eliminates the entire interfering signal causing RF signal 108 to include only the wanted signal. In some implementations, the interfering signal attenuates by an amount in proportion to RF feedback signal 168.

In some implementations, receiver 100 suppresses the interfering signal below the operating noise floor in less than 1 micro-second. In some implementations, receiver 100 eliminates the effects of the interfering signal on the wanted signal in less than 1 micro-second. In some implementations, receiver 100 reduces the interfering signal by 50 dB in less than 1 micro-second. In some implementations, receiver 100 reduces the interfering signal by 40 dB in less than 1 micro-second. In some implementations, receiver 100 reduces the interfering signal by 30 dB in less than 1 micro-second. In some implementations, receiver 100 reduces the interfering signal by 20 dB in less than 1 micro-second. In some implementations, receiver 100 reduces the interfering signal by 10 dB in less than 1 micro-second.

In some implementations, receiver 100 suppresses the interfering signal below the operating noise floor in less than 2 micro-seconds. In some implementations, receiver 100 eliminates the effects of the interfering signal on the wanted signal in less than 2 micro-seconds. In some implementations, receiver 100 reduces the interfering signal by 50 dB in less than 2 micro-seconds. In some implementations, receiver 100 reduces the interfering signal by 40 dB in less than 2 micro-seconds. In some implementations, receiver 100 reduces the interfering signal by 30 dB in less than 2 micro-seconds. In some implementations, receiver 100 reduces the interfering signal by 20 dB in less than 2 micro-seconds. In some implementations, receiver 100 reduces the interfering signal by 10 dB in less than 2 micro-seconds.

Local oscillators 122, 124, 158, 160 are tuned to the center frequency of incoming RF signal 104. The frequency down-converting stage of receiver 100 includes mixers 118, 120 and local oscillators 122, 124. The frequency up-converting stage of receiver 100 comprises mixers 154, 156 and local oscillators 158, 160. Each oscillator is tuned to the wanted frequency of incoming RF signal 104. The signal applied to mixers 120, 156 from respective local oscillators 124, 160 is in quadrature with the local oscillator signals applied to mixers 118, 154 from respective local oscillators 122, 158. Accordingly, mixers 118, 120 down-convert corrected RF signal 112 from an RF signal to an in-phase baseband signal 126 and a quadrature-phase baseband signal 128 by mixing RF signal 112 with each respective oscillator signal.

Mixer 154 mixes extracted in-phase interfering signal 150 with local oscillator 158 to up-convert extracted in-phase interfering signal 150 from a baseband signal to an RF signal, referred to as in-phase RF feedback signal 162. Similarly, mixer 156 up-converts extracted quadrature-phase interfering signal 152 from a baseband signal to an RF signal, referred to as quadrature-phase RF feedback signal 164, by mixing extracted quadrature-phase interfering signal 152 with local oscillator 160.

By way of a non-limiting example, mixers 118, 120, 154, 156 may be implemented as a single-ended mixer, a balanced mixer, a double-balanced mixer, an image-rejection mixer, or image-recovery mixer. Those skilled in the art will appreciate the possible need to modify receiver 100 based on the mixer selected to implement receiver 100.

Filters 130, 132 attenuate the unwanted out-of-band signals from in-phase baseband signal 126 and quadrature-phase baseband signal 128 to produce filtered in-phase and quadrature-phase baseband signals 134, 136. By way of a non-limiting example, filters 130, 132 may be a fixed bandpass filter, a tunable bandpass filter, a low-pass filter, a high-pass filter, a passband filter, a band-reject filter, a notch filter, a programmable filter, or a transimpedance filter. In some implementations, receiver 100 may not need filters 130, 132. For example, filters 130, 132 become less useful if mixers 118, 120 perform channel selectivity at their output.

ADC 138 converts filtered in-phase and quadrature-phase baseband signals 134, 136 from analog signals to digital signals. As shown in FIG. 1, filtered signals 134, 136 route to in-phase correlator 146 and quadrature-phase correlator 148 prior to ADC 138. That is, in-phase correlator 146 and quadrature-phase correlator 148 each receive analog feedback signals. Accordingly, in some implementations, ADC 138 may be optional.

ADC 138 may delay the sending of filtered in-phase and quadrature-phase baseband signals 134, 136 to a downstream device (e.g., baseband processor) based on exceeding a predetermined threshold. For example, ADC 138 may delay the signals until the power of the interfering signal of amplified RF signal 108 falls below a predetermined threshold (e.g., 60 dB, 55 dB, 50 dB, 45 dB, 40 dB, 35 dB, 30 dB, 25 dB, 20 dB, 15 dB, 10 dB, or 5 dB), with respect to the power of the wanted signal of amplified RF signal 108.

ADC 138 may delay the sending of filtered in-phase and quadrature-phase baseband signals 134, 136 to a downstream device (e.g., baseband processor) based on falling below a predetermined threshold. For example, ADC 138 may measure the power of the interfering signal with respect to the wanted signal and store the measurement as M1. For the next cycle of incoming RF signal 104, ADC 138 may repeat the measurement and store the measurement as M2. If ADC 138 determines that M2-M1 is less than a predetermined threshold (e.g., 1 dB, 2 dB, 3 dB, 4 dB, 5 dB, 10 dB, 20 dB), then ADC 138 may send filtered in-phase and quadrature-phase baseband signals 134, 136 to a downstream device.

ADC 138 may delay the sending of filtered in-phase and quadrature-phase baseband signals 134, 136 to a downstream device for a predetermined amount of time (e.g., 1 us, 2 us, 3 us, 4 us, 5 us, 10 us, 20 us, 30 us, 40 us, 50 us, 1 ms, 2 ms, 3 ms, 4 ms, 5 ms, 10 ms, 20 ms, 30 ms, 40 ms, 50 ms, or any combination thereof).

The predetermined threshold and the predetermined amount of time may change based on varying conditions, such as the modulation scheme of incoming RF signal 104, the received power of incoming RF signal 104, the noise floor of the system, a calculated RSSI, or the number of in-band interfering signals.

A downstream device, such as a baseband processor, may include the delay features of ADC 138. Accordingly, the down-stream device receives the filtered in-phase and quadrature-phase baseband signals 134, 136 from receiver 100 directly. In response, the down-stream device may delay the processing of the signals, for example, until the satisfaction of a predetermined threshold or predetermined time, as described herein.

Receiver 100 may include a digital-to-analog (DAC) converter. For example, a DAC may connect between ADC 138 and each correlator 146, 148. The DAC may first receive filtered in-phase and quadrature-phase baseband signals 134, 136 from ADC 138 as digital signals, and then convert the signals back to the analog domain prior to sending the signals to each correlator 146, 148. In some implementations, correlators 146, 148 receive filtered in-phase and quadrature-phase baseband signals 134, 136 from a DAC associated with a baseband processor.

Each correlator may receive digital feedback signals. For example, the feedback paths may connect the input of each correlator to the output of ADC 138 instead of the input of ADC 138. Thus, ADC 138 drives each correlator with digital versions of filtered in-phase and quadrature-phase baseband signals 134, 136. In some implementations, each correlator may receive both analog and digital signals.

The feedback path of receiver 100 includes in-phase correlator 146 and quadrature-phase correlator 148, referred to generally as correlators 146, 148. Correlators 146, 148 each measure the similarity between two analog signals (single-ended to single-ended, or differential to differential) and produce an analog output signal (single-ended or differential) that represents the degree of that measured similarity. In other words, correlators 146, 148 compare the characteristics (e.g., magnitude, phase) of a received signal to another signal, such as a reference signal. Correlators 146, 148 will produce a signal that perfectly, or nearly perfectly, mirrors the magnitude and phase of the searched signal if correlators 146, 148 identify a match between the signals. In some implementations, the magnitude and phase of the output signal may be proportional to, or associated with, the magnitude and phase of the searched signal. Insertion loss or other RF degrading effects (e.g., coupling, non-linear characteristics) may cause the differences in magnitude and phase between the compared signal and the searched signal.

In some instances, the searched signal may include multiple signals or a signal modulated by other signals. For example, antenna 102 may receive incoming RF signal 104, which includes a wanted signal component and an interfering signal component caused by an aggressor (e.g., a transmit signal coupling back into receiver 101 through a duplexer). The down-conversion (and filtering) of incoming RF signal 104 produces IQ baseband signals (e.g., filtered in-phase and quadrature-phase baseband signals 134, 136) that also include the wanted signal component and the interfering signal component. If correlators 146, 148 compare the down-converted IQ baseband signals (i.e., searched signal) to the IQ baseband signals of the aggressor (i.e., reference signal), then correlators 146, 148 may identify similarities between the IQ baseband signals of the aggressor and the interfering signal component of the down-converted IQ baseband signals. That is, the aggressor's RF signal that caused the interfering signal component in the incoming RF signal correlates to the IQ baseband signal of that same aggressor. Accordingly, correlators 146, 148 extract the interfering signal component from the IQ down-converted baseband signals, effectively treating the wanted signal as unwanted noise. The extracted signals appear on the output of correlator 146 as in-phase interfering signal 150 and the output of correlator 148 as extracted quadrature-phase interfering signal 152. Each extracted signal has a magnitude and phase that matches the magnitude and phase of the filtered down-converted IQ baseband signals 134, 136.

In some implementations, correlators 146, 148 may extract signals from digital baseband signals, instead of analog baseband signals. For example, as discussed herein, ADC 138 may convert filtered in-phase and quadrature-phase baseband signals 134, 136 from analog to digital signals. ADC 138 may send these signals to correlators 146, 148 to use during the signal extraction process.

Combiner 166 has two-inputs and one-output adapted to add the signal sensed on its first input with the signal sensed on its second input to produce a combined signal on its output. As shown in FIG. 1, combiner 166 will add in-phase RF feedback signal 162 and quadrature-phase RF feedback signal 164, to produce RF feedback signal 168, which is an RF composite signal.

The components shown in FIG. 1 may have an alternate configuration. For example, one implementation of receiver 100 may position subtractor 110 prior to LNA 106. As a result, receiver 100 removes (or attenuates) the interfering signal from incoming RF signal 104 before amplifying and passing incoming RF signal 104 to the down-converting stage (e.g., mixer 118, 120). In other implementations, receiver 100 may include one or more additional LNAs placed after subtractor 110. For example, a second LNA stage with a programmable or fixed signal gain may follow subtractor 110 to compensate for the insertion loss caused by the tap of subtractor 110. In other implementations, a third LNA stage with a programmable or fixed signal gain may follow the second LNA stage to amplify corrected RF signal 112 further and prior to mixers 118, 120. In some implementations, the signal gain of LNA 106, the second LNA stage, and the third LNA stage may be identical. In other implementations, the gain of each LNA stage may be different. In other implementations, receiver 100 may include a switch placed between combiner 166 and subtractor 110 to bypass the feedback path of correlators 146, 148. For example, receiver 100 may bypass the feedback path by opening the switch when the power level of a jammer (e.g., an interfering signal component in incoming RF signal 104) received by antenna 102 falls below a predetermined threshold value. Receiver 100 may engage the feedback path by closing the switch when the power level of a jammer received by antenna 102 rises above a predetermined threshold value. In some implementations, a processor or modem may control the opening and closing of the switch based on the power level of a jammer.

Receiver 100 may include one or more LNAs between combiner 166 and subtractor 110 to offset the signal loss between the two components. For example, antenna 102 may receive an incoming RF signal that includes a −60 dBm wanted signal and a −50 dBm interfering signal—i.e., the interfering signal is 10 dB larger than the wanted signal. However, the process of down-converting the incoming RF signal, extracting the correlated signal, and subsequently up-converting the combined extracted signal may have the effect of producing an RF feedback signal that is only 5 dB more than the wanted signal. Thus, the one or more LNAs may eliminate the 5 dB error by amplifying the RF feedback signal by 5 dB.

The down-converted baseband signals may also route to each correlator prior to any filtering. For example, in-phase baseband signal 126 and quadrature-phase baseband signal 128 may connect to correlators 146, 148 instead of filtered down-converted IQ baseband signals 134, 136. This example configuration may be useful in cases where ADC 138 requires filtering of the down-converted baseband signals, but correlators 146, 148 must process unfiltered baseband signals. Thus, in this implementation, filters 130, 132 may be tuned to the requirements of ADC 138 without distorting the performance of correlators 146, 148.

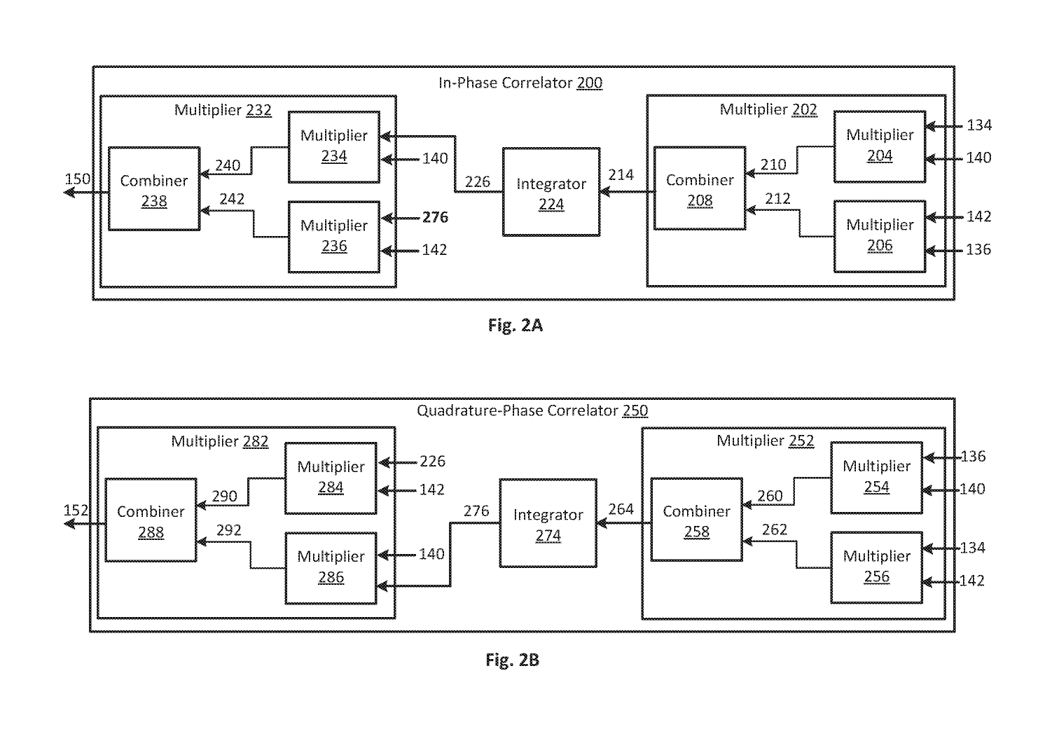

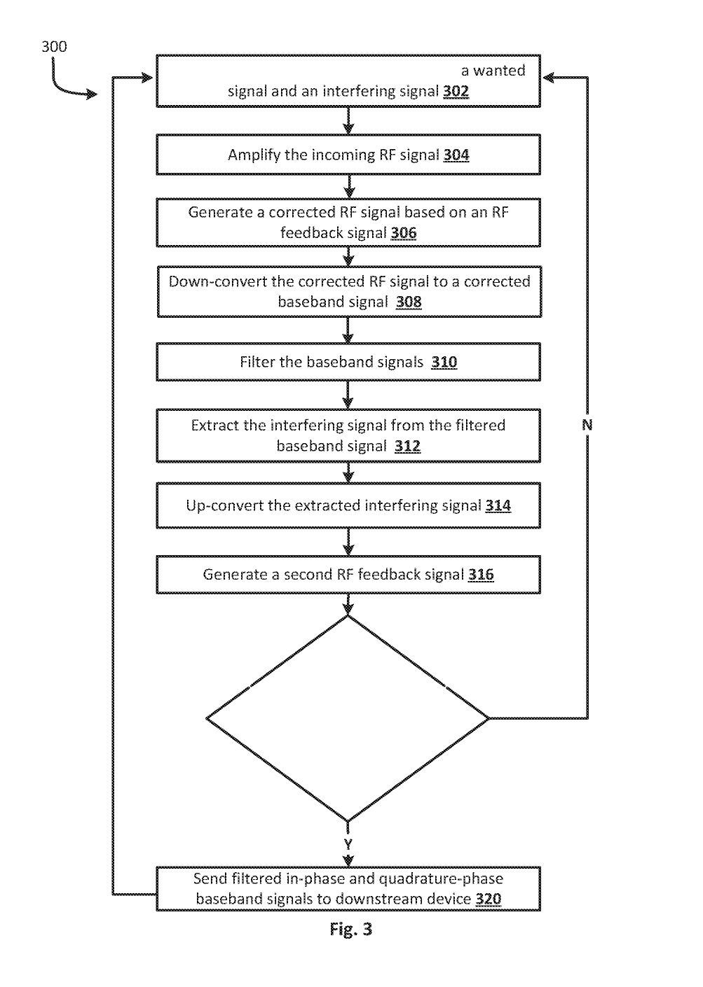

FIG. 2A is a block diagram depicting an in-phase correlator 200 (such as in-phase correlator 146) capable of extracting an in-phase baseband signal correlated to an in-phase aggressor signal, in accordance with an illustrative implementation. In-phase correlator 200 includes two multipliers 202, 232 and one integrator 224. Multiplier 202 includes two multipliers 204, 206 and one combiner 208. Multiplier 232 includes two multipliers 234, 236 and one combiner 238. In other implementations, in-phase correlator 200 can include fewer, additional, and/or different components.

The inputs of multiplier 204 connect to in-phase baseband signal 134 and in-phase aggressor baseband signal 140, and output signal 210 of multiplier 204 connects to the first input of combiner 208. The inputs of multiplier 206 connect to quadrature-phase baseband signal 136 and quadrature-phase aggressor baseband signal 142, and output signal 212 of multiplier 206 connects to the second input of combiner 208. Output signal 214 of combiner 208 connects to the input of integrator 224.

The inputs of multiplier 234 connect to output signal 226 and in-phase aggressor baseband signal 140, and output signal 240 of multiplier 234 connects to the first input of combiner 238. The inputs of multiplier 236 connect to quadrature-phase aggressor baseband signal 142 and output signal 276 of integrator 274 (discussed below), and output signal 242 of multiplier 236 connect to the second input of combiner 238. The output signal of combiner 238 (e.g., extracted in-phase interfering signal 150) connects to the input of mixer 154.

FIG. 2B is a block diagram depicting a quadrature-phase correlator 250 (such as quadrature-phase correlator 148 described with reference to FIG. 1) capable of extracting a quadrature-phase baseband signal correlated to a quadrature-phase aggressor signal, in accordance with an illustrative implementation. Quadrature-phase correlator 250 includes two multipliers 252, 282 and one integrator 274. Multiplier 252 includes two multipliers 254, 256 and one combiner 258. Multiplier 282 includes two multipliers 284, 286 and one combiner 288. In other implementations, in-phase correlator 250 can include fewer, additional, and/or different components.

The inputs of multiplier 254 connect to quadrature-phase baseband signal 136 and in-phase aggressor baseband signal 140, and output signal 260 of multiplier 254 connects to the first input of combiner 258. The inputs of multiplier 256 connect to in-phase baseband signal 134 and quadrature-phase aggressor baseband signal 142, and output signal 262 of multiplier 256 connects to the second input of combiner 258. Output signal 264 of combiner 258 connects to the input of integrator 274.

The inputs of multiplier 284 connect to output signal 226 and quadrature-phase aggressor baseband signal 142, and output signal 290 of multiplier 284 connects to the first input of combiner 288. The inputs of multiplier 286 connect to in-phase aggressor baseband signal 140 and output signal 276 of integrator 274, and output signal 292 of multiplier 286 connects to the second input of combiner 288. The output signal of combiner 288 (e.g., extracted quadrature-phase interfering signal 152) connects to the input of mixer 156.

Referring to both FIG. 2A and FIG. 2B, multipliers 204, 206, 234, 236, 254, 256, 284, 286 generate an output signal by multiplying their respective input signals together. Each multiplier may perform multiplication in the time domain (via the convolution theorem) or in the frequency domain (via a point-wise multiplication). In some implementations, each multiplier may perform an array of other mathematical operations applied to their respective inputs, such as subtraction, addition, division, and exponentiation.

Similar to combiner 166 (described herein), combiners 208, 238, 258, 288 each have two-inputs and one-output adapted to generate a combined signal on its output by adding the signal sensed on its first input with the signal sensed on its second input. In some implementations, each combiner may perform an array of other mathematical operations applied to their respective inputs, such as multiplication, subtraction, division, and exponentiation.

Integrators 224, 274 integrate a received RF energy over a predetermined sample time. Integrators 224, 274 may be a simple capacitor or an operational amplifier integrator circuit.

Correlators 200, 250 determine the degree in which two signals are similar or different in phase and magnitude. The degree of correlation is maximum when the two signals are similar and minimum when the two signals are different. In-phase correlator 200 extracts one or more in-phase signals by multiplying (e.g., multiplication or convolution) the complex conjugate of the frequency spectrum of one signal by the frequency spectrum of the other. Quadrature-phase correlator 250 also extracts one or more quadrature-phase signals by a similar process.

Equations 1 and 2, relating an in-phase extracted signal (e.g., extracted in-phase interfering signal 150) to a searched signal (e.g., filtered down-converted IQ baseband signals 134, 136) and a reference signal (e.g., IQ baseband signals of an aggressor 140, 142), are presented below.

Output signal 226, L_{int—i}, of integrator 224 can be determined using, for example:

∫ₐ^{b}[(Idc*IAggr)+(Qdc*QAggr)]dt, (1)

where I_{dc}, is in-phase aggressor baseband signal 140, I_{Aggr}, is in-phase aggressor baseband signal 140, Q_{dc} is quadrature-phase baseband signal 136, Q_{Aggr} is quadrature-phase aggressor baseband signal 142, ‘a’ is the lower limit of integration, and ‘b’ is the upper limit of integration.

Extracted in-phase baseband signal 150 at the output of combiner 238 can be determined using, for example:

lint_i*IAggr+Qint_i*QAggr, (2)

where I_{int—q} is output signal 276 (see below).

Equations 3 and 4, relating a quadrature-phase extracted signal (e.g., extracted quadrature-phase interfering signal 152) to a searched signal (e.g., filtered down-converted IQ baseband signals 134, 136) and a reference signal (e.g., IQ baseband signals of an aggressor 140, 142), are presented.

Output signal 276, I_{int—q}, of integrator 274 can be determined using, for example:

∫ₐ^{b}[(Qdc*IAggr)+(Idc*QAggr)]dt, (3)

where I_{dc}, is in-phase aggressor baseband signal 140, I_{Aggr} is in-phase aggressor baseband signal 140, Q_{dc} is quadrature-phase baseband signal 136, Q_{Aggr} is quadrature-phase aggressor baseband signal 142, ‘a’ is the lower limit of integration, and ‘b’ is the upper limit of integration.

Extracted in-phase baseband signal 152 at the output of combiner 288 can be determined using, for example:

lint_i*QAggr+Qint_q*IAggr, (4)

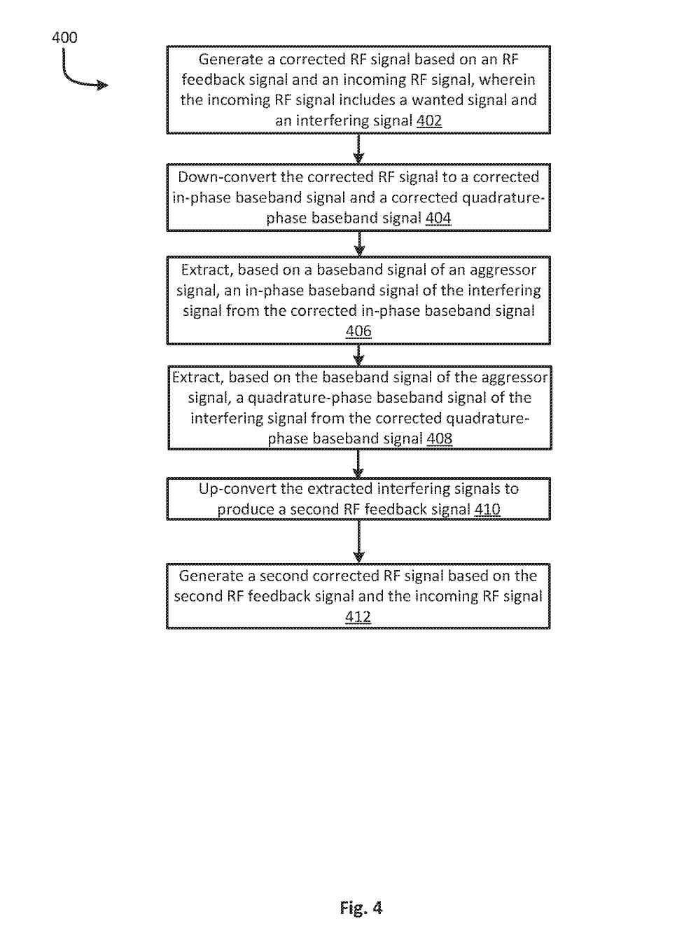

FIG. 3 is a flow diagram depicting a process for canceling interference from a received RF signal in accordance with an example implementation. Additional, fewer, or different operations may be performed depending on the implementation of the process. Referring to FIGS. 1-3, the process 300 may be implemented by a system such as the receiver 100. At operation 302, the system receives an incoming RF signal from a frequency band having a plurality of wanted RF channels and interfering RF channels.

At operation 304, LNA 106 amplifies the incoming signal with a fixed gain stage(s), a variable gain stage(s), or any combination of fixed and variable gain stages.

At operation 306, subtractor 110 generates corrected RF signal 112 based on an RF feedback signal. For example, subtractor 110 subtracts RF feedback signal 168 from amplified signal 108, to produce corrected RF signal 112. Accordingly, for each cycle of amplified RF signal 108, subtractor 110 further attenuates the interfering signal component of amplified RF signal 108 relative to the wanted signal component. The corrected RF signal includes the wanted RF channel and an interfering RF channel.

At operation 308, the mixers 118, 120 frequency convert the corrected RF signal to in-phase and quadrature-phase (I/Q) baseband signals. For example, local oscillators 122, 124 are tuned to the wanted frequency of incoming RF signal 104. The signal applied to mixer 120 from local oscillators 124 is in quadrature with the local oscillator signal applied to mixers 118 from local oscillators 122. Accordingly, mixers 118, 120 down-convert corrected RF signal 112 from an RF signal to an in-phase baseband signal 126 and a quadrature-phase baseband signal 128 by mixing RF signal 112 with each respective oscillator signal. In some implementations, the system converts the corrected RF signal to an intermediate or low-IF frequency prior to converting to a baseband frequency.

At operation 310, filters 130, 132 filter the IQ baseband signals to improve channel selectively. For example, the roll-off frequency (e.g., 3 dB point) of filters 130, 132 are appropriately selected to attenuate the unwanted out-of-band signals from in-phase baseband signal 126 and quadrature-phase baseband signal 128 to produce filtered in-phase and quadrature-phase baseband signals 134, 136. In some implementations, the filtering removes noise from receiver 100 to improve the performance for the downstream devices, such a baseband processor.

At operation 312, correlators 146, 148 extract the interfering signal from the filtered IQ baseband signals. For example, correlators 146, 148 implement an extraction process that measures the similarity between two analog signals (single-ended to single-ended, or differential to differential) and produces an analog output signal (single-ended or differential) that represents the degree of that measured similarity. In one implementation, correlators 146, 148 extract the signals from filtered in-phase and quadrature-phase baseband signals 134, 136 (in the analog domain) based on a comparison to the aggressor signal. As discussed herein, the aggressor signal relates to the interfering RF channel. In some implementations, filtered in-phase and quadrature-phase baseband signals 134, 136 are in the digital domain.

At operation 314, receiver mixers 150, 156 frequency convert each extracted I/Q error signal from a baseband frequency to a radio frequency. For example, local oscillators 158, 160 are tuned to the wanted frequency of incoming RF signal 104. Mixer 154 mixes extracted in-phase interfering signal 150 with local oscillator 158 to up-convert extracted in-phase interfering signal 150 from a baseband signal to an RF signal, referred to as in-phase RF feedback signal 162. Similarly, mixer 156 up-converts extracted quadrature-phase interfering signal 152 from a baseband signal to an RF signal, referred to as quadrature-phase RF feedback signal 164, by mixing extracted quadrature-phase interfering signal 152 with local oscillator 160.

At operation 316, combiner 166 generates a second RF feedback signal. For example, generating the second RF feedback signal 168 includes combining or adding in-phase RF feedback signal 162 and quadrature-phase RF feedback signal 164 (i.e., each at RF) into a composite RF signal.

At operation 318, receiver 100 measures the power of the interfering signal relative to the wanted signal and compares to the measurement to a predetermined threshold. If the measurement does not exceed the predetermined threshold, then receiver 100 returns to operation 302. If the measurement does exceed the predetermined threshold, then receiver 100 continues to operation 320. Receiver 100 skips operation 318 when the power of the interfering signal reduces to levels resulting in optimal performance for receiver 100. In some implementations, the governing telecommunication standards and regulations define the optimal performance for receiver 100. In some implementations, operation 318 may be based on a predetermined amount of time, as described herein.

At operation 320, receiver 100 sends the filtered in-phase and quadrature-phase baseband signals 134, 136 to a downstream device (e.g., baseband processor, ADC) for processing and returns to operation 302 to repeat the process.

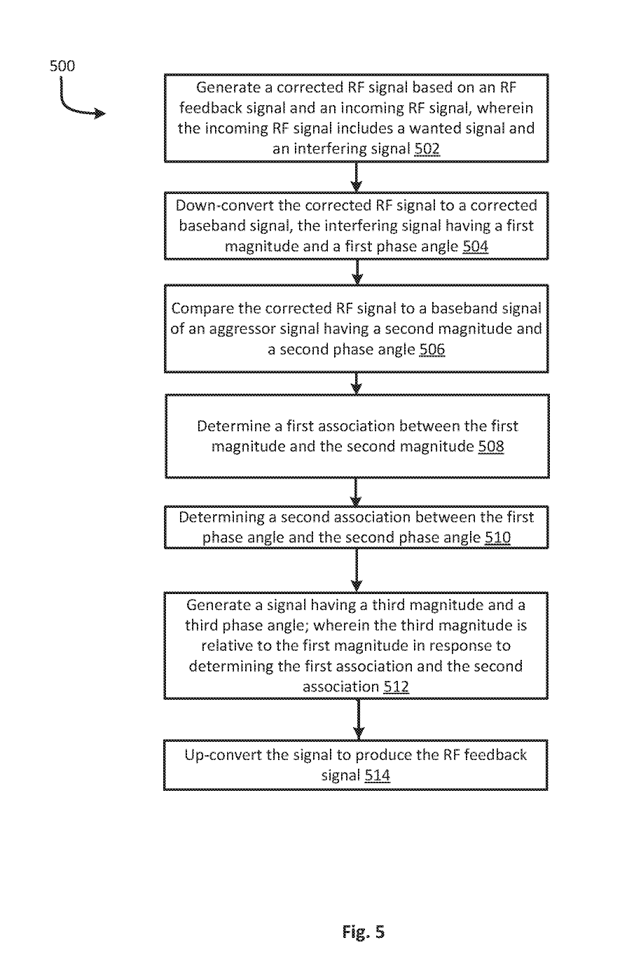

FIG. 4 is a flow diagram depicting a process for canceling interference from a received RF signal. Additional, fewer, or different operations may be performed depending on the implementation of the process. Referring to FIGS. 1-4, each of operations 402-410 corresponds to one or more of operations 302-320. The process 400 may be implemented by a system such as the receiver 100 described with reference to FIG. 1.

At operation 402, subtractor 110 generates corrected RF signal 112 based on RF feedback signal 168 and incoming RF signal 104. The incoming RF signal includes the wanted signal and the interfering signal.

At operation 404, mixers 118, 120 down-convert the corrected RF signal 112 to corrected in-phase baseband signal 126 and corrected quadrature-phase baseband signal 128.

At operation 406, in-phase correlator 146 extracts, based on a baseband signal of an aggressor signal (e.g., in-phase aggressor baseband signal 140), an in-phase baseband signal 150 of the interfering signal from corrected in-phase baseband signal 126.

At operation 408, quadrature-phase correlator 148 extracts, based on the baseband signal of the aggressor signal (e.g., quadrature-phase aggressor baseband signal 142), a quadrature-phase baseband signal 152 of the interfering signal from corrected quadrature-phase baseband signal 128.

At operation 410, mixers 154, 156 up-convert the extracted interfering signals to produce the RF feedback signal 168.

At operation 412, subtractor 110 generates a second corrected RF signal based on the second RF feedback signal and incoming RF signal 104.

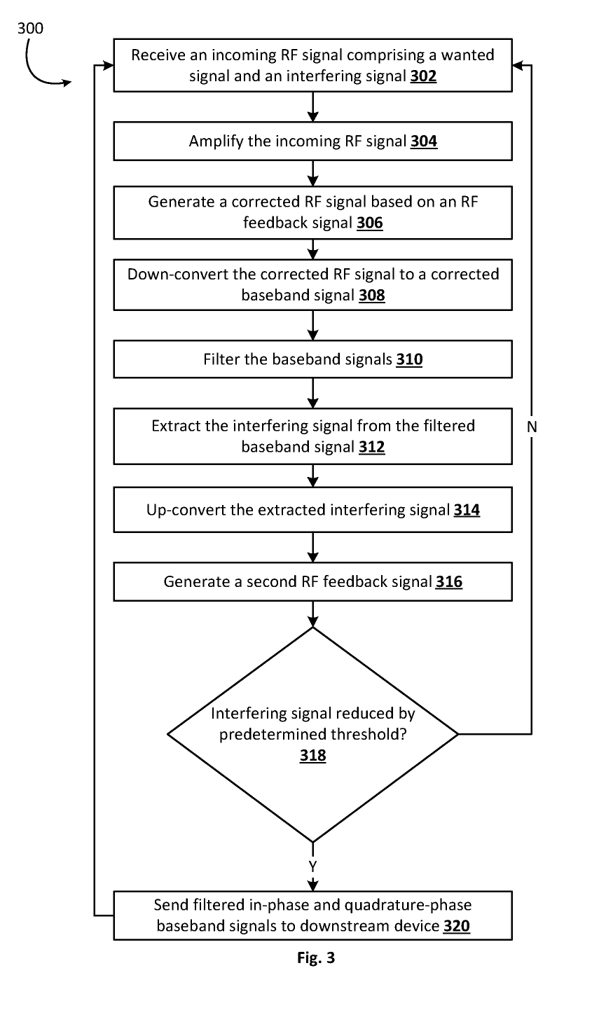

FIG. 5 is a flow diagram depicting a process for canceling interference from a received RF signal. Additional, fewer, or different operations may be performed depending on the implementation of the process. Referring to FIGS. 1-4, each of operations 502-514 corresponds to one or more of operations 302-320. The process 500 may be implemented by a system such as the receiver 100 described with reference to FIG. 1.

At operation 502, subtractor 110 generates corrected RF signal 112 based on RF feedback signal 168 and incoming RF signal 104. The incoming RF signal includes the wanted signal and the interfering signal.

At operation 504, mixers 118, 120 down-convert the corrected RF signal 112 to corrected in-phase baseband signal 126 and corrected quadrature-phase baseband signal 128.

At operation 506, correlators 146, 148 compare corrected RF signal 112 to a baseband signal of an aggressor signal (e.g., in-phase aggressor baseband signal 140, quadrature-phase aggressor baseband signal 142) having a second magnitude and a second phase angle 506.

At operation 508, correlators 146, 148 determine a first association between the first magnitude and the second magnitude.

At operation 510, correlators 146, 148 determine a second association between the first phase angle and the second phase angle.

At operation 512, correlators 146, 148 generate a signal having a third magnitude and a third phase angle. The third magnitude is relative to the first magnitude in response to determining the first association and the second association.

At operation 514, mixers 154, 156 up-convert the signal to produce the RF feedback signal 514.

The various implementations illustrated and described are provided merely as examples to illustrate various features of the claims. However, features shown and described with respect to any given implementation are not necessarily limited to the associated implementation and may be used or combined with other implementations that are shown and described. Further, the claims are not intended to be limited by any one example implementation.

The foregoing method descriptions and the process flow diagrams are provided merely as illustrative examples and are not intended to require or imply that the steps of various implementations must be performed in the order presented. As will be appreciated by one of skill in the art the order of steps in the foregoing implementations may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary implementations, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed implementations is provided to enable any person skilled in the art to make or use the present disclosure. Various modifications to these implementations will be readily apparent to those skilled in the art, and the generic principles defined herein may be applied to some implementations without departing from the spirit or scope of the disclosure. Thus, the present disclosure is not intended to be limited to the implementations shown herein but is to be accorded the widest scope consistent with the following claims and the principles and novel features disclosed herein.

1. A method of processing a received signal, the method comprising:
generating a corrected radio frequency (RF) signal based on an RF feedback signal and an incoming RF signal, the incoming RF signal including a wanted signal and an interfering signal;
down-converting the corrected RF signal to provide a corrected in-phase baseband signal and a corrected quadrature-phase baseband signal;
extracting an in-phase analog baseband signal of the interfering signal by a first correlator based on an in-phase aggressor signal, a quadrature aggressor signal, and the corrected in-phase baseband signal;
extracting a quadrature-phase analog baseband signal of the interfering signal by a second correlator based on the in-phase aggressor signal, the quadrature aggressor signal and the corrected quadrature-phase baseband signal;
up-converting the extracted in phase baseband signal of the interfering signal and the quadrature-phase analog baseband signal of the interfering signal to provide a second RF feedback signal; and
generating a second corrected RF signal based on the second RF feedback signal and the incoming RF signal.

2. The method of claim 1, wherein generating the corrected RF signal comprises subtracting the RF feedback signal from the incoming RF signal, and wherein generating the second corrected RF signal comprises subtracting the second RF feedback signal from the incoming RF signal.

3. (canceled)

4. The method of claim 1, wherein the interfering signal of the incoming RF signal is correlated to a baseband signal of an aggressor signal, wherein the baseband signal of the aggressor signal comprises an in-phase baseband signal and a quadrature-phase baseband signal.

5. (canceled)

6. The method of claim 4, wherein an analog to digital conversion of the corrected in-phase baseband signal and the corrected quadrature-phase baseband signal is delayed until a power of the interfering signal is below a predetermined threshold.

7. The method of claim 4, wherein the incoming RF signal is amplified prior to generating the corrected RF signal.

8. The method of claim 4, wherein the corrected RF signal is amplified prior to down-converting the corrected RF signal.

9. The method of claim 4, wherein extracting the in-phase baseband signal of the interfering signal comprises:
generating a first multiplier signal based on the corrected quadrature-phase baseband signal;
generating an in-phase integrated signal based on the first multiplier signal; and
generating the in-phase baseband signal of the interfering signal based on the in-phase integrated signal.

10. The method of claim 9, wherein extracting the interfering signal from the corrected quadrature-phase baseband signal comprises:
generating a third multiplier signal based on the corrected in-phase baseband signal;
generating a quadrature-phase integrated signal based on the third multiplier signal; and
generating the quadrature-phase analog baseband signal of the interfering signal based on the quadrature-phase integrated signal.

11. The method of claim 9, wherein generating the first multiplier signal comprises:
generating a fifth multiplier signal based on a multiplication of the corrected in-phase baseband signal and the in-phase baseband signal of the aggressor signal;
generating a sixth multiplier signal based on a multiplication of the corrected quadrature-phase baseband signal and the quadrature-phase baseband signal of the aggressor signal; and
generating the first multiplier signal based on a combination of the fifth multiplier signal and the sixth multiplier signal.

12. The method of claim 10, wherein generating the in-phase baseband signal of the interfering signal comprises:
generating a ninth multiplier signal based on a multiplication of the in-phase integrated signal and the in-phase baseband signal of the aggressor signal;
generating a tenth multiplier signal based on a multiplication of the quadrature-phase integrated signal and the quadrature-phase baseband signal of the aggressor signal; and
generating the in-phase baseband signal of the interfering signal based on a combination of the ninth multiplier signal and the tenth multiplier signal.

13. The method of claim 12, wherein generating a third multiplier signal based on the corrected in-phase baseband signal comprises:
generating a seventh multiplier signal based on a multiplication of the corrected quadrature-phase baseband signal and the in-phase baseband signal of the aggressor signal;
generating an eighth multiplier signal based on a multiplication of the corrected in-phase baseband signal and the quadrature-phase baseband signal of the aggressor signal; and
generating the third multiplier signal based on a combination of the seventh multiplier signal and the eighth multiplier signal.

14. The method of claim 13, wherein generating the quadrature-phase baseband signal of the interfering signal comprises:
generating an eleventh multiplier signal based on a multiplication of the in-phase integrated signal and the quadrature-phase baseband signal of the aggressor signal;
generating a twelfth multiplier signal based on a multiplication of the quadrature-phase integrated signal and the in-phase baseband signal of the aggressor signal; and
generating the quadrature-phase baseband signal of the interfering signal based on a combination of the eleventh multiplier signal and the twelfth multiplier signal.

15. A communication circuit, comprising:
a subtractor configured to generate a corrected radio frequency (RF) signal based on an incoming RF signal and an RF feedback signal, the incoming RF signal including a wanted signal and an interfering signal;
a down-converter configured to frequency convert the corrected RF signal to a corrected in-phase baseband signal and a corrected quadrature-phase baseband signal;
a first correlator configured to extract an in-phase analog baseband signal of the interfering signal based on an in-phase aggressor signal, a quadrature aggressor signal, and the corrected in-phase baseband signal;
a second correlator configured to extract a quadrature-phase analog baseband signal of the interfering signal based on the in-phase aggressor signal, the quadrature aggressor signal, and the corrected quadrature-phase baseband signal; and
an up-converter configured to frequency convert the extracted in-phase analog baseband signal of the interfering signal and the quadrature-phase analog baseband signal of the interfering signal to provide a second RF feedback signal.

16. The communication circuit of claim 15, wherein the subtractor is further configured to generate the corrected RF signal by subtracting the RF feedback signal from the incoming RF signal.

17. (canceled)

18. The communication circuit of claim 15, wherein the interfering signal of the incoming RF signal is correlated to a baseband signal of an aggressor signal, wherein the baseband signal of the aggressor signal comprises an in-phase baseband signal and a quadrature-phase baseband signal.

19. (canceled)

20. The communications circuit of claim 18, further comprising:
a low noise amplifier (LNA), configured to amplify the incoming RF signal provided to the subtractor.

21. The communications circuit of claim 18, further comprising:
a low noise amplifier (LNA) configured to amplify the corrected RF signal provided to the down-converter.

22. The communications circuit of claim 16, further comprising:
a first low-pass filter configured to filter the corrected in-phase baseband signal of the corrected RF signal provided to the first correlator; and
a second low-pass filter configured to filter the corrected quadrature-phase baseband signal of the corrected RF signal provided to the second correlator.

23. The communications circuit of claim 18, wherein the first correlator comprises:
a first multiplier configured to generate a first multiplier signal based on the corrected quadrature-phase baseband signal;
an in-phase integrator configured to generate an in-phase integrated signal based on the first multiplier signal; and
a second multiplier configured to generate the in-phase baseband signal of the interfering signal based on the in-phase integrated signal.

24. The communications circuit of claim 23, wherein the second correlator comprises:
a third multiplier configured to generate a third multiplier signal based on the corrected in-phase baseband signal;
a quadrature-phase integrator configured to generate a quadrature-phase integrated signal based on the third multiplier signal; and
a fourth multiplier configured to generate the quadrature-phase baseband signal of the interfering signal based on the quadrature-phase integrated signal.

25. The communications circuit of claim 23, wherein the first multiplier comprises:
a fifth multiplier configured to generate a fifth multiplier signal based on the corrected in-phase baseband signal and the in-phase baseband signal of the aggressor signal;
a sixth multiplier configured to generate a sixth multiplier signal based on the corrected quadrature-phase baseband signal and the quadrature-phase baseband signal of the aggressor signal; and
a first in-phase combiner configured to generate the first multiplier signal based on the fifth multiplier signal and the sixth multiplier signal.

26. The communications circuit of claim 24, wherein the second multiplier comprises:
a ninth multiplier configured to generate a ninth multiplier signal based on the in-phase integrated signal and the in-phase baseband signal of the aggressor signal;
a tenth multiplier configured to generate a tenth multiplier signal based on the quadrature-phase integrated signal and the quadrature-phase baseband signal of the aggressor signal; and
a second in-phase combiner configured to generate the in-phase baseband signal of the interfering signal based on the ninth multiplier signal and the tenth multiplier signal.

27. The communications circuit of claim 26, wherein the third multiplier comprises:
a seventh multiplier configured to generate a seventh multiplier signal based on the corrected quadrature-phase baseband signal and the in-phase baseband signal of the aggressor signal;
an eighth multiplier configured to generate an eighth multiplier signal based on the corrected in-phase baseband signal and the quadrature-phase baseband signal of the aggressor signal; and
a first quadrature-phase combiner configured to generate the third multiplier signal based on the seventh multiplier signal and the eighth multiplier signal.

28. The communications circuit of claim 27, wherein the fourth multiplier comprises:
an eleventh multiplier configured to generate an eleventh multiplier signal based on in-phase integrated signal and the quadrature-phase baseband signal of the aggressor signal;
a twelfth multiplier configured to generate a twelfth multiplier signal based on the quadrature-phase integrated signal and the in-phase baseband signal of the aggressor signal; and
a second quadrature-phase combiner configured to generate the quadrature-phase baseband signal of the interfering signal based on the eleventh multiplier signal and the twelfth multiplier signal.

29. A non-transitory computer readable storage medium storing instructions that, when executed by a processor of a device, cause the device to:
generate a corrected radio frequency (RF) signal based on an RF feedback signal and an incoming RF signal, the incoming RF signal including a wanted signal and an interfering signal;
down-convert the corrected RF signal to provide a corrected in-phase baseband signal and a corrected quadrature-phase baseband signal;
extract, an in-phase analog baseband signal of the interfering signal by a first correlator based on an in-phase aggressor signal, a quadrature aggressor signal, and the corrected in-phase baseband signal;
extract a quadrature-phase analog baseband signal of the interfering signal by a second correlator based on the in-phase aggressor signal, the quadrature aggressor signal and, the corrected quadrature-phase baseband signal; and
up convert the extracted in phase analog baseband signal of the interfering signal and the quadrature-phase analog baseband signal of the interfering signal to provide the RF feedback signal.

30. (canceled)

31. A communication circuit, comprising:
a subtractor configured to generate a corrected radio frequency (RF) signal based on an incoming RF signal and an RF feedback signal, the incoming RF signal comprising a wanted signal and an interfering signal, wherein the interfering signal of the incoming RF signal is correlated to a baseband signal of an aggressor signal and the baseband signal of the aggressor signal comprises an in-phase baseband signal and a quadrature-phase baseband signal;
a down-converter configured to frequency convert the corrected RF signal to a corrected in-phase baseband signal and a corrected quadrature-phase baseband signal;
a first correlator configured to extract the in-phase baseband signal of the interfering signal from the corrected in-phase baseband signal, wherein the first correlator comprises:
a first multiplier configured to generate a first multiplier signal based on the corrected quadrature-phase baseband signal;
an in-phase integrator configured to generate an in-phase integrated signal based on the first multiplier signal; and
a second multiplier configured to generate the in-phase baseband signal of the interfering signal based on the in-phase integrated signal;
a second correlator configured to extract the quadrature-phase baseband signal of the interfering signal from the corrected quadrature-phase baseband signal; and
an up-converter adapted to frequency convert the extracted interfering signals to produce a second RF feedback signal, the second corrected RF signal including the incoming RF signal having a majority of the interfering signal removed.
